(19) United States
(12) Patent Application Publication
(10) Pub. No.: US 2025/0083377 A1
(43) Pub. Date: Mar. 13, 2025

(54) SYSTEM FOR HYBRID HIGH-THROUGHPUT ADDITIVE DEPOSITION MODELLING, AND A METHOD FOR OPERATING THEREOF

(71) Applicant: THE GOVERNORS OF THE UNIVERSITY OF ALBERTA, Edmonton (CA)

(72) Inventors: Rafiq Ahmad, Edmonton (CA); Roberto Monroy, Edmonton (CA); David Moises Baca Lopez, Edmonton (CA); Miguel Eduardo Castillo Asuaje, Edmonton (CA); Tanay Kuclourya, Edmonton (CA)

(21) Appl. No.: 18/883,577

(22) Filed: Sep. 12, 2024

Related U.S. Application Data
(60) Provisional application No. 63/582,217, filed on Sep. 12, 2023.

(51) Int. Cl. B29C 64/118; B29C 64/209; B29C 64/336; B29C 64/393; B29K 105/26; B33Y 10/00; B33Y 30/00; B33Y 50/02

(52) U.S. Cl. CPC B29C 64/118; B29C 64/209; B29C 64/336; B29C 64/393; B33Y 10/00; B33Y 30/00; B33Y 50/02; B29K 2105/26

(57) ABSTRACT

Embodiments herein generally relate to the use of a hybrid system, which employs a combination of fused filament deposition (FFD) and direct fused deposition (DFD) modelling systems. The hybrid system can be used with both virgin as well as recycled plastics, and is suitable for multicomponent as well as multi-material printing of a broad range of thermoplastic materials. Owing to the capability of the system to re-use a variety of different plastics for the purpose of plastic printing, the system promotes the “Circular Economy” strategy for part production whereby material after life-use can be easily reincorporated into the supply chain to avoid plastic accumulation.

### FIELD

The present invention generally relates to additive manufacturing systems (e.g., three-dimensional (3D) printing), and more particularly, to a system for hybrid high-throughput additive deposition modelling, and a method for operating thereof.

### BACKGROUND

Plastic waste is considered one of the leading environmental problems of the day, and consequently, the demand for techniques to recycle plastic has gained prominence in the global industry.

To this end, additive manufacturing (AM) or three-dimensional (3D) printing, is recognized as a method for reducing plastic waste. Plastic waste can be re-used as a feedstock for the preparation of value-added materials during the AM manufacturing process.

More generally, AM or 3D printing is a manufacturing process whereby an object is built by converting a digital version of a part into its physical 3D form by adding material layer-by-layer. In the case of plastic products, most systems melt plastic raw material in the form of filament, powders, or pellets, and selectively deposit the material through a nozzle to form the final desired part or component.

AM is more agile in producing parts and prototypes compared to conventional plastic transformation processes, where special molds and large, robust equipment are required. Moreover, AM processes are not constrained by geometrical complexity of parts as it is with available mold-making subtractive techniques. In addition, rapid mass customization and on-demand production are more economically feasible using AM processes.

AM processes are, however, still considered to be slow manufacturing processes when compared to conventional manufacturing technologies. The lack of available materials for 3D printing of an object, the type of extrusion heads to print any specific plastic material, the limited speed, printing parameters, control, performance, and building volume in existing machines, and the high cost of materials are some of the downsides that this technology faces.

### SUMMARY AND ASPECTS OF EMBODIMENTS

Embodiments herein generally relate to the use of a hybrid system, which employs a combination of fused filament deposition (FFD) and direct fused deposition (DFD) modelling systems. The hybrid system can be used with both virgin and recycled plastics, and is suitable for multicomponent as well as multi-material printing of a broad range of thermoplastic materials. The hybrid system can re-use a variety of different plastics for the purpose of plastic printing, and accordingly the system promotes recycling and recirculation in a “Circular Economy” strategy for part production to avoid plastic accumulation.

In view of the description below, herein below are described certain more particularly described aspects of the invention. These particularly recited aspects should not however be interpreted to have any limiting effect on any different claims containing different or more general teachings described herein, or that specific aspects are somehow limited in some way other than the inherent meanings of the language literally used therein.

1. A system for hybrid high-throughput additive deposition modelling, comprising:
(a) a fused filament deposition (FFD) subsystem;
(b) a direct fused deposition (DFD) subsystem;
(c) a motion assembly for moving the FFD and DFD subsystems along X, Y and Z axes; and (d) a controller configured to move both the FFD and the DFD subsystems in three dimensions, and control the deposition of plastic material by each of the FFD and DFD subsystems.

2. The system of aspect 1 wherein the DFDM subsystem comprises a screw-extruder.

3. The system of aspect 1 or 2, wherein the FFD subsystem comprises an extruder fan, cooling fan, heater, and temperature sensor, each operatively connected to the controller.

4. The system of aspect 1 or 2 wherein the DFD subsystem comprises a nozzle, at least one heater, a temperature sensor, a cooling fan, and a stepper servo driver motor for rotating the screw-extruder, each operatively connected to the controller.

5. The system of aspect 4 wherein the nozzle is sized to deliver a filament diameter size between about 1.75 mm to about 2.5 mm and/or a material flow rate of up to about 5 mm³/s.

6. The system of any one of aspects 1-5 wherein the system is configured to produce a part having at least one FFD zone and at least one DFD zone, and the controller is configured to control the FFD subsystem to deposit material in the at least one FFD zone and to control the DFD subsystem to deposit material in the at least one DFD zone.

7. A method of producing a part by additive deposition, wherein the part has at least one FFD zone and at least one DFD zone, the method comprising the step of operating a hybrid additive deposition system comprising an FFD subsystem and a DFD subsystem to deposit material in the at least one FFD zone using the FFD subsystem and in the at least one DFD zone using the DFD subsystem.

8. The method of aspect 7 wherein either or both the FFD subsystem and the DFD subsystem are fed with recycled plastic material.

9. The method of aspect 7 wherein material is deposited in the at least one DFD zone with a filament size between about 1.75 mm to about 2.5 mm and/or a material flow rate of up to about 5 mm³/s.

10. A system of hybrid high-throughput additive deposition modelling, comprising any combination or subcombination of element(s), feature(s) or mean(s)-plus-function described herein.

11. A method of producing a part by additive deposition, comprising any combination of step(s) or step(s)-plus-function described herein.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is an example system for hybrid additive deposition modeling, in accordance with embodiments herein.

FIG. 2 is an illustration of the system for hybrid additive deposition modeling.

FIG. 3 shows one or more images of a system for hybrid additive deposition modeling.

FIG. 4 is a simplified hardware block diagram for an example system for hybrid additive deposition modeling.

FIG. 5 is an example direct fused deposition (DFD) modelling subsystem.

FIG. 6 shows various images of a barrel and screw arrangement for an example DFD modelling subsystem, as well as a corresponding screw extruder assembly.

FIG. 7 is an illustration of an example screw geometry, that can be used in a DFD modelling subsystem.

FIG. 8 shows one or more images of an example hopper design that can be used with a DFD modelling subsystem.

FIG. 9 is an example method for hybrid additive deposition modeling, in accordance with embodiments herein.

FIG. 10 are images of a 3D component being printed using DFD and FFD nozzles.

### DETAILED DESCRIPTION OF THE EMBODIMENTS

### I. Definitions

Any term or expression not expressly defined herein shall have its commonly accepted definition understood by a person skilled in the art. As used herein, the following terms have the following meanings.

“Additive Manufacturing (AM)” is generally known in the art, and refers to a set of manufacturing techniques which involve depositing material layer-by-layer to create a net shape part. In many cases, the manufacturing or building process is based on a virtual model generally generated using computer assisted design. Examples of additive manufacturing include three-dimensional (3D) printing and rapid prototyping.

“Fused Filament Deposition (FFD) Modelling (FFDM)” refers to an AM technique in which filaments are extruded through a heated nozzle and deposited over a platform, layer-by-layer, to print 3D models.

“Direct Fused Deposition (DFD) Modelling (DFDM)” refers to an AM technique in which pellets or flakes are extruded through a nozzle (e.g., via a screw extrusion assembly) and deposited over a platform, layer-by-layer, to print 3D models.

“Processor” refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors.

“Memory” refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

### II. General Overview

Additive manufacturing (AM) (e.g., 3D printing) is a manufacturing process wherein an object is built by converting a digital version of a part into its physical 3D form by adding material layer by layer. Examples of AM technologies include fused deposition modelling (FDM) and direct-FDM (DFDM) technologies, which aim toward the use of recycled materials to promote zero waste manufacturing. While FDM technology uses plastic filaments for layer-by-layer material deposition, DFDM directly uses shredded or pelletized plastics for 3D printing.

AM has been considered, however, a slow manufacturing process when compared to conventional manufacturing technologies. Further, different AM processes have different mechanisms which have their own limitations. For instance, some polymers are not readily available in filaments, which restricts their use as an ideal printing material in the FDM process. In particular, the extra step of heating these plastics into filaments, is usually unfavorable for certain types of plastic materials. Accordingly, FDM may not be compatible with various virgin or recycled types of plastics materials which are not yet resolved for this type of process.

In some examples, plastics that are not adapted for the FDM process can be better suited for a direct extrusion, or DFDM process. Many commercial DFDM systems work on extrusion additive manufacturing (EAM), which rely on melting pellets or flakes of plastic (i.e., not filaments). These systems can contain screw-based print heads, which have an auger screw that helps transport the molten plastic material. As these systems can be directly fed with shredded or pelletized materials, the technology has emerged as an enabling technology that expands the range of 3D printing materials, as these are no more restricted by their mechanical properties in the filament form or by their performance in the filament extrusion process or even by the tolerance requirements. EAM processes also reduce feedstock fabrication costs and increase the rate of material deposition when compared to the traditional FDM process.

In one aspect, described herein is a hybrid system, which employs both FDM and DFDM processes. Such a hybrid system allows using a greater variety of recycled plastic that can be either in filament form (e.g., for FDM processes), or pellet/flake form (e.g., for DFDM processes). Hybrid configurations can achieve printing selectively at high deposition rates, without substantially compromising part quality.

Disclosed embodiments employ a novel configuration where a large-scale 3D printing additive manufacturing machine can print parts components at high deposition rates with fused filament deposition (FFD) using plastics in filament form, and/or direct fused deposition (DFD) with either polymer pellets, small size particles or flakes.

In some embodiments, a hybrid system which is configured to manufacture a part which includes both at least one DFD part zone and at least one FDM part zone, which require higher printed layer resolutions based on the part's mechanical quality requirements, can be combined with printing zones where a faster production rate is needed, as explained further below.

In some examples, using the disclosed hybrid system configuration, layer printing deposition rates can significantly increase (e.g. up to four times) compared to normal FDM capabilities, and the use of raw materials from plastic wasted parts is expanded. This, in turn, mitigates the environmental problem generated by plastic waste accumulation through the “Circular Economy” cost-benefit strategy where material after life-use can be easily reincorporated into the supply chain.

### III. Example Overall System

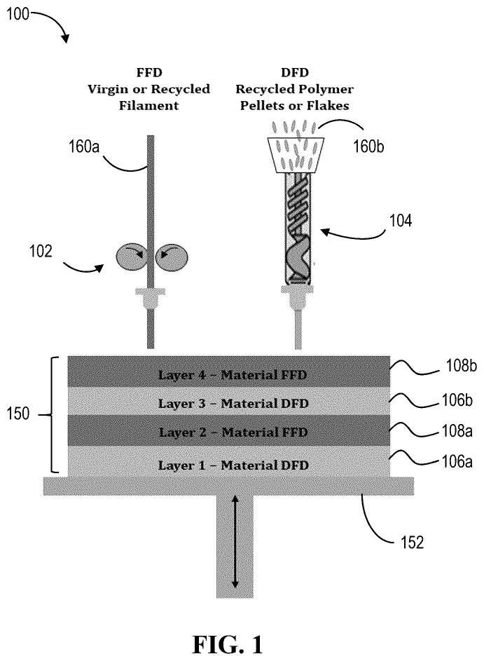

FIG. 1 shows an example system (100) for hybrid additive deposition modeling, in accordance with embodiments herein.

As shown, system (100) includes a 3D printing head extruder design with a nozzle configuration to print parts at a larger scale size and with high deposition rates, and within the same carriage.

In more detail, the system (100) includes: (i) a filament fused deposition (FFD) subsystem (102), with an FFD head extruder, and (ii) a direct fused deposition (DFD) subsystem (104), with a DFD header extruder. As disclosed herein, the DFD subsystem (104) may have a screw-extruding design.

As shown, the FFD subsystem (102) is fed plastic in filament form (160a) (e.g., virgin or recycled). Further, the DFD subsystem (104) can be fed plastics in pellet or flake form (160b) (e.g., recycled polymer pellets or flakes).

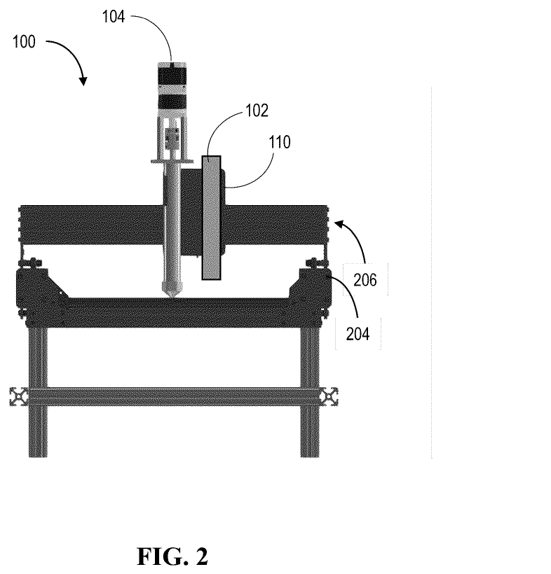

In some examples, the FFD and DFD subsystems (102), (104) can be mounted to a common mounting structure (110) (FIG. 2) (e.g., a mounting plate), which allows the subsystems (102), (104) to be moved together.

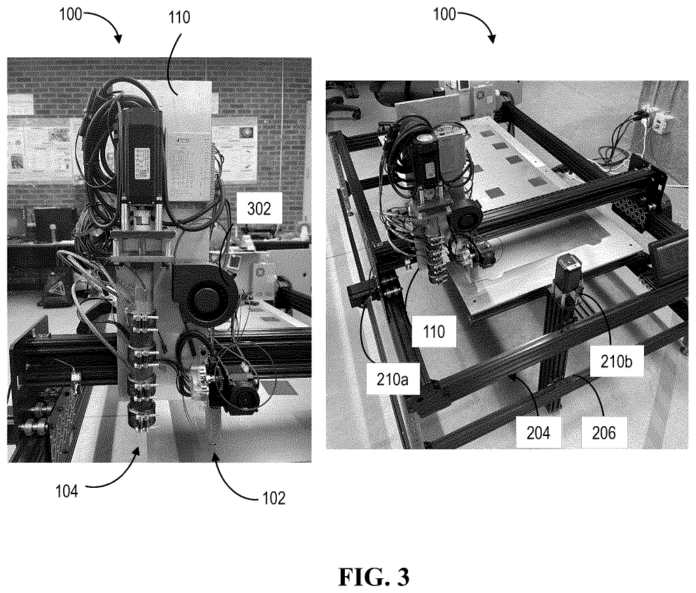

As shown in FIGS. 2 and 3, the mounting structure (110) can be coupled to a motion assembly (204), forming part of the hybrid system (100). The motion assembly (204) can comprise a frame (206) with sliding components, and one or more actuating motors (210a)-(210b) for sliding the mounting structure (110)—and therefore, the FFD and DFD subsystems (102), (104)—along multiple axis (e.g., X, Y and Z axis). In this manner, the FFD and DFD subsystems (102), (104) can be moved around to print 3D parts, layer-by-layer.

Continuing with reference to FIG. 1, as further exemplified, system (100) can be used to manufacture a part or component (150) comprising multiple overlaid layers (106), (108). These can include a combination of layers that include DFD printed layers (106a), (106b), as well as FFD printed layers (108a), (108b), as required. The part (150) can be printed over the printing platform assembly (152).

In some examples, system (100) can manufacture parts (150) using a combination of plastic types, which are configured in either filament form (e.g., using FFD system (102)), as well as in pellet or flake form (e.g., using DFD system (104)). This is achieved by integrating multiple 3D printing technologies into a single manufacturing platform. The disclosed hybrid system (100) can lead to higher throughputs with faster printing speeds and thicker printing layers.

In at least one example, areas or zones requiring faster printing speed are printed using the DFD nozzle. To this point, there is a relation between the printing speed and the extruding speed. For example, if the printing nozzle is moving at 20 mm/s, then the DFD's screw extruder should be rotated at a speed high enough to provide sufficient material at the nozzle, which may be approximately 20 RPM. In this manner, the screw is rotating and extruding higher material throughputs. In some examples, DFD can achieve filament diameter sizes in the range of approximately 1.75 mm to 2.5 mm, and allowing maximum layer thickness of up to approximately 2.5 mm. This is contrasted to typical filament diameters in the range of 1.25 to 1.75 mm, and maximum layer thickness of around 0.08 to 1.25 mm when extruded. Accordingly, using DFD, printing speed can be increased up to 2 to 3 times per layer owing to greater filament diameter size and thickness.

The system (100) can also selectively use FFD to print zones of the plastic parts where higher resolutions, based on the part performance, are required, as FFD can allow for smaller layer thickness, which is better suited to achieve smaller filament diameter sizes. In this manner, FFD can print detailed parts with higher resolution. In some examples, higher resolution parts or zones printed with FFD can include external or outward facing components, requiring higher levels of detail (e.g., parts requiring fine details, corners, decorative surfaces, engraved letters, etc.)

More generally, the disclosed hybrid system allows for versatility of product design, with a higher production rate and final cost reduction. Furthermore, in terms of the environmental problems generated by plastic waste, the system promotes the “Circular Economy” strategy for part production where material after life-use can be easily reincorporated into the supply chain to avoid plastic accumulation. This is because the plastic can either be configured in filament form, or in the form of pellets or flakes, e.g., depending on the plastic type.

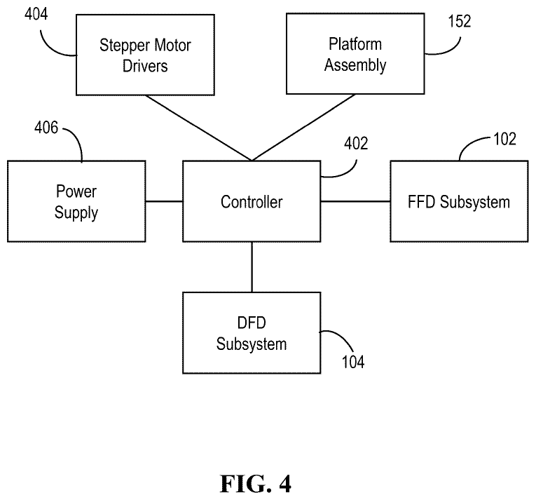

FIG. 4 shows a simplified hardware block diagram for the hybrid system (100).

As shown, a controller (402) is provided, and includes a processor and a memory (not shown). The memory can store various instructions, including the method flows disclosed herein, which are executed by the processor.

In some examples, controller (402) comprises, or incorporates, a computational numeric controller (CNC), and can be used to control the motion assembly (402) in order to set the displacement of both deposition systems at a controlled value.

Controller (402) is connected to one or more stepper motor drivers (404) (e.g., six stepper drivers), which are part of the motion assembly (204) (FIGS. 2 and 3). In disclosed embodiments, the controller (402) can couple to at least five stepper drives associated with motors in the motion assembly (204) (e.g., one for x-direction, two for y-direction, and two for z-direction) for movement in the three axes. Controller (402) can also connect to one end stop sensor each for x and y-direction.

In some examples, controller (402) also couples to various electronic components of the platform assembly (152) (FIG. 1). This includes coupling to one or more platform heaters (e.g., two heaters), as well as solid-state relays for the heaters and thermocouples.

Controller (402) additionally connects to various elements of the FFD subsystem (102), including an extruder fan, cooling fan, heater, and temperature sensor. Similarly, controller (402) can connect to components of the DFD subsystem (104), including coupling to band heaters, temperature sensors for these heaters, cooling fan, as well as a stepper servo driver of the motor used for the screw-extruding rotation.

A power source (406) may also be provided for powering the system, which is also connected to the controller (402).

In at least one example, the entire hardware arrangement is controlled by RepRap @Firmware (version 3.4), loaded on the controller memory. This is an object-oriented C++ control program for self-replicating 3D printers. The G codes are sent to the software using, e.g., a a Duet3 Web interface through Wi-Fi.

### IV. Example DFD Subsystem

In the disclosed embodiments, the DFD subsystem (104) may have a screw-extruding configuration. The screw-type design is important to melting recycled plastic and for printing material layer depositions to produce different shape geometries.

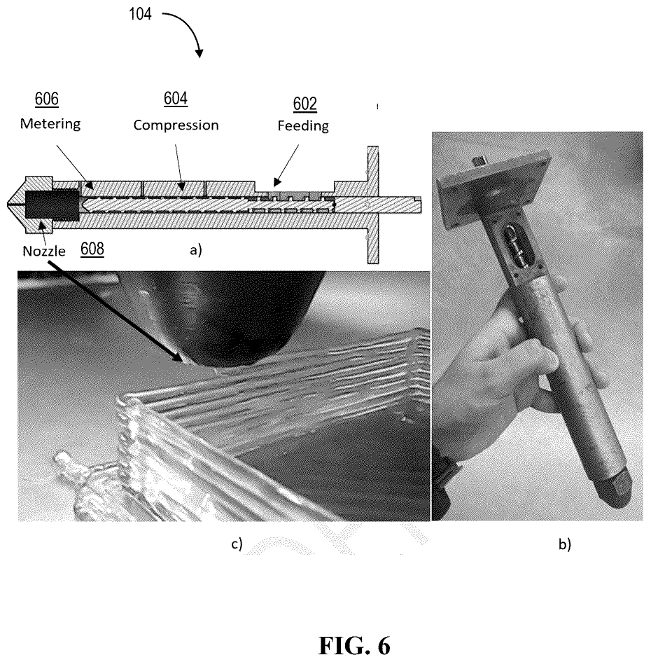

As best shown in FIG. 6, the screw-type DFD subsystem (104) can include a feeding zone (602), a compression zone (604), a metering zone (606), and the extruding nozzle (608).

Two important features of the DFD subsystem (104) are the construction material particle design, and nozzle design.

In some examples, plastic particles—that are fed into the DFD subsystem (104)—are approximately 2 mm in size. These can be agglomerate material in the feeding, compression, and metering zone of the screw-barrel component. As typically material recycled particles can be easily obtained from commercial shredders with this kind of particle size, in at least one example, the screw-extruding configuration is calculated and fabricated to be able to extrude and melt thermoplastic polymers with this type of characteristic.

The nozzle (608) can be a detachable nozzle. The detachable nozzle tip configuration can have diameters ranging from 1.75 to 2.5 mm, and can be implemented in the end barrel section.

While typical FDM systems deposit layers within the range of 0.4 mm up to 0.8 mm thickness, the disclosed assembly is preferably designed to reach up to 2.0 or even 2.5 mm thickness deposition layer, which makes the system able to print higher throughputs that reduce printing time and consequently increase the efficiency of the printing process.

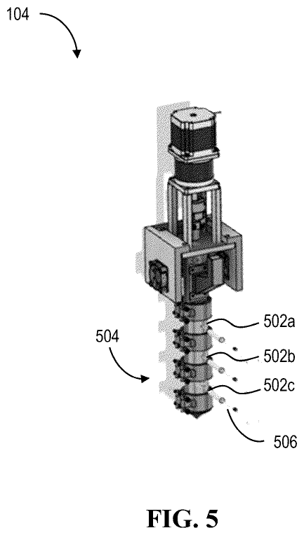

Another important consideration is the relation between the rheological and thermal properties of most commercial plastics. In this matter, the disclosed Barrel-Screw-Nozzle configuration contains one or more heating zones (502) (FIG. 5) to allow the melted plastic transfer while printing with sufficient flow rate inside the barrel, presenting high pressure and extruding material continuously while layers are being deposited. In the exemplified embodiment, the DFD subsystem (104) includes three heating zones (502a), (502b) and (502c), arranged on the barrel portion (504).

The system is designed with a view to the maximum and minimum melt extrusion temperature for the materials to be processed and the temperature dependence on polymer melt viscosity versus shear stress produced inside the extruding barrel (504).

### (i.) Mechanical Design of the Screw and Selection.

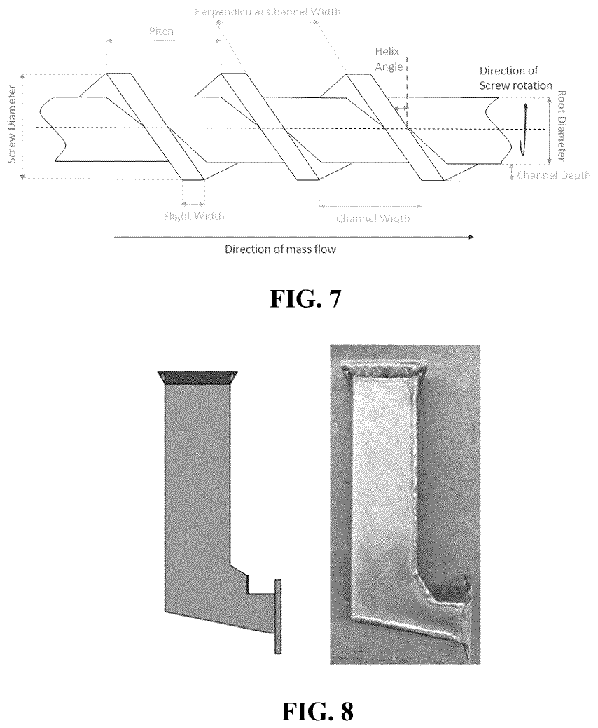

The screw is a very important component of the extrusion system and is often referred as the heart of the extruder. The geometry of the screw is critical in terms of the efficiency of the entire extrusion system. The parameters involved in a screw geometry are channel depth, channel width, pitch, helix angle, etc. Varying any of these parameters can change the physical properties of the screw. FIG. 7 shows the various components of screw geometry.

The screw length (L) and diameter (D) are two other important parameters of a screw extrusion system. It has been previously shown that the L/D ratio should be less than or equal to 20 for melt extruders for an efficient extrusion. Table 1, below, shows the standard values of different screw parameters.

TABLE 1
Screw parameters.

| Screw parameters | Standard values (from literature) |
|---|---|
| Length to diameter ratio (L/D) | 20 or less for melt extruders |
| Diameter (D) | 20, 25, 30, 35, 40, 50, 60, 90, 120, 150, |
| | 200, 250, 300, 350, 400, 450, 500 and |
| | 600 mm |
| Helix angle (Φ) | 17.65° or 0.308 rad, for 0.8 < L_{S}/D < 1.2 |
| | (where L_{S} is pitch length) Channel depth |
| | (h) in metering section 0.05 D-0.07 D for |
| | D < 30 mm, 0.02 D-0.05 D for D > 30 |
| | mm Clearance between screw and barrel |
| | (δ) 0.1 mm for D < 30 mm, 0.15 mm for |
| | D > 30 mm |

To minimize the gravity induced deflections in the shaft, the screw is preferably placed in a vertical position. On the other hand, to reduce the lateral deflections, the rotation speed of the screws is intended to be low. The symmetrical sustentation provided by the molten polymers also helps in reducing the lateral deflections. Inside the screw geometry, the transportation of material takes place through conveying elements. These elements have a varying pitch, which leads to the required flow compression. FIG. 6 shows the sectional view of the screw and the barrel arrangement used.

In at least one example, the screw has a diameter of 11.75 mm, whereas the barrel has an inner diameter of 11.8 mm, leaving a small clearance of 0.025 mm in between. Table 2 shows all the remaining dimensions of the screw used. The nozzle has a diameter of 1.75 mm. The screw, barrel, and nozzle are made of stainless steel and hence have good corrosion resistance and long service life.

TABLE 2
Example screw geometry dimensions.

| S. No. | Screw geometry parameter | Value | |
|---|---|---|---|
| 1 | Channel width (W) | 9.5 | mm |
| 2 | Channel depth (H) | H1 = 3.5 mm, H2 = 3 mm, | |
| | | H3 = 2 mm, H = Hₐᵥₑ = 2.83 mm | |
| 3 | Diameter of screw (Dₛ) | 11.75 | mm |
| 4 | Inner diameter of barrel (D) | 11.80 | mm |
| 5 | Outer diameter of barrel | 35.60 | mm |
| | (Do) | | |
| 6 | Thickness of barrel (t) | 11.90 | mm |
| 7 | Clearance between screw | 0.025 | mm |
| | and barrel | | |
| 8 | Helix angle of screw (Φ) | 0.359 | rad |

| | | |
|---|---|---|
| 9 | Length of the screw (L) | L1 = 65 mm, L2 = 65 mm, |
| | | L3 = 60 mm, L = 190 mm |

It has been previously shown that irrespective of the LID ratio, the length of the feed zone should be constant throughout, and the remainder of the length should be dedicatedly used for melting and pumping.

While more channel depth results in higher specific output (lb/rpm), a larger length of the screw is taken into account in order to create the pressure required to push out the polymer from the nozzle. Excessive length for the overall processing situation may limit the output of the system, and can result in excessive melt temperature, which leads to color shift, polymer degradation, loss of adhesiveness, etc.,. The length of the melting zone can be reduced if the polymer melts easily, as excessive length can compromise the melting rate. Lastly, for the metering zone, the length can be reduced on using proper melt pumps which can withstand the discharge pressure.

To increase the output, the LID ratio can be increased. However, the feed section is able to deliver polymer only up to a certain quantity limit which in turn limits the increment of ratio LID. For screws having a smaller diameter, this limit is determined by the screw strength. The channel depth can be increased up to a point where the screw can bear the torque generated from the rotation. On the other hand, for larger extruders, the channel depth can be increased till there is an increment in the output. Increasing the channel depth beyond this point often reduces the efficiency of feeding. Hence, the L/D ratio is an important parameter as larger values of it may penalize the overall performance of the system.

To create an internal pressure to extrude the material, the material is compressed along the length of the screw. This compression is possible due to the linearly increasing core diameter of the screw. A stepper motor is used to rotate the screw in small increments to impart constant mass flow for a smooth printing process. Also, to prevent any damage due to the misalignment of the screw and barrel, the latter is preferably made from harder steel than the former.

For higher throughput, which is often desirable, larger extruders are preferred. However, at the same time, it should also be noted that while an oversized extruder provides the flexibility of having a higher output, it also results in higher daily operating costs. The capital investment can increase up to double on moving up one extruder size. Large extruders have more residence time for a specific output, increasing the chance of polymer degradation. Additionally, the heat-up and temperature requirements are proportional to the mass of the extruder. The time required for heating the extruder can double on increasing one size of the extruder.

Even at low speed, the AC and DC drives extract high power per unit mass of the output. Due to poor power factors at low speed, DC drives are costlier than AC drives. The large surface area of a larger heated extruder also results in increased thermal losses to the environment, which may be beneficial in cold weather but significantly increases the cost in warm weather. Accordingly, it may be preferred to use a small-sized extruder.

Yet another important component of the screw extruder assembly is the nozzle as it is responsible for shaping the output of the polymer as well as generating pressure inside the extruder. It was observed that the smaller the nozzle size, the more pressure is required by the screw to extrude the material. The end barrel section implements a detachable nozzle tip configuration with diameters ranging from 1.75 to 2.5 mm.

Typical FDM systems can deposit layers within the range of 0.4 mm up to 0.8 mm thickness, whereas the disclosed system preferably reachs up to 2 mm thickness deposition layer, which makes the system able to print higher throughputs that reduce printing time and consequently increase the efficiency of the printing process. However, the use of the 2.5 mm nozzle can result in unstable prints due to die-swelling issues during extrusion. Hence, a 1.75 mm nozzle may also be preferred. On the other hand, a 1.4 mm nozzle has been used for the FDM system.

### (ii.) Hopper Design

Since the material is gravity assisted, it becomes important to design the hopper in such a way that there is precise control of the material feed rate to avoid jamming, possibly leading to inconsistencies in print.

FIG. 8 shows an example design and the machined hopper used in the disclosed system. A concerning issue in the hopper system is the agglomeration of the material near the screw-hopper assembly. As the screw passes through the center of the barrel, the pellets or shredded pieces in large numbers present inside the hopper act like a barrier to the rising heat and do not allow it to escape, resulting in the heat absorption by pellets and forming agglomerates. These large groups can stall the screw and prevent the downward movement of material, eventually starving the extruder. To transport the pellets at a fixed rate, an auger screw can also be used inside the hopper.

### (iii.) Thermal Band Heaters and Sensors.

To allow the screw to be filled with melted polymer at an initial stage, it is important to heat the barrel (504) (FIG. 5) to obtain a temperature suitable for the polymer to stick to the surface. The angle of the screw flights then pushes the polymer forward. After the barrel heating, the energy provided to the polymer comes entirely from the screw rotation relative to the barrel, which leads to the polymer's melting by shear. The polymer inside the extruder gets heated to a viscoelastic melt when subjected to shear forces. The trapped air between the melted polymer is expelled by virtue of the pressure developed by the screw geometry. It also helps to overcome the back pressure induced by the nozzle geometry. The screw rotation speed and the object thickness directly affect the shear rate. Hence polymers experience zero shears at the screw root and maximum shear at the barrel surface. The compression section of a screw preferably comprises a gradually reducing channel depth which forces any unmelted polymer towards the barrel wall to impart maximum shear.

Heat may be provided using any suitable heater, preferably an electric band heater is used as it is easy to use and control the heat characteristics. The temperature of the heaters is controlled using temperature sensors.

In at least one example, four band heaters (e.g., (502) in FIG. 5) are used in the system. In some examples, these band heaters have a power of 225 W operating at 120 V, a maximum heat output of 350° C., and are placed at various locations at the barrel (504) surface. A temperature sensor (e.g., PT1000™ temperature sensor) can be installed for each of the heaters to control their temperature individually if required. It can measure temperatures up to 400° C. FIG. 5 shows an example arrangement of the heaters (502) as well as the temperature sensor (506).

Although heating is an important and essential aspect of the extrusion process, there is a possibility of an upward flow of heat through the screw and the hopper, which can be detrimental as it can lead to the partial melting of the material and convert them into agglomerates. Hence, to prevent this backward flow of heat, a cooling system can be installed close to the neck of the extruder. Hence the current design consists of a cooling fan (302) (FIG. 3), which is installed at the junction of the hopper and the barrel of the extruder, as shown in FIG. 3.

Lastly, to improve the thermal insulation of the extruder in order to avoid the premature melting of the small-sized particles, the walls of the barrel (504) can be insulated with mineral wool.

### (iv.) Stepper Motor and Encoder

Apart from the screw geometry, the rotation of the screw is another important aspect of a screw extrusion system. The rotation of the screw pressurizes the plastic, due to which it moves and gains the heat from the barrel under friction. An appropriate amount of power is needed to rotate the screw to carry on the screw extrusion mechanism. As for the case of the direct fused deposition element, the target to reach 5 mm³/s as a maximum flow rate serves as the baseline to select the electric engine which can push the melted material at a continuous rate.

A large fraction of the drive power (almost 85%) is used for the screw rotation, and the remaining power is used for mixing, pressurizing, and forwarding the melted polymer. During the screw rotation process, the barrel heaters are in a cooling mode for a large duration and have almost no contribution to melting the polymers. However, the initial barrel heating decreases the power requirement from the drive. The viscosity of the polymer during shearing is directly related to the energy imparted by the screw drive. As preheated polymers have less viscosity, less power is required for melting and remainder processes.

In the exemplified design, a closed loop NEMA 23-sized stepper servo motor is used. It has a 1.8-degree step angle, up to 3 N-m holding torque, and maximum current consumption of 4 A and operates at a DC voltage of 24-50 V. Hence, the maximum power output is around 200 Watts. It has a built-in encoder having a high resolution of 4000 pulses per revolution. The encoder ensures high precision and no loss of step. In addition, the motor also has a stepper driver with a maximum step count of 40000 steps and 16 types of micro steps, which allows accurate functioning of encoder feedback. The motor shaft has a diameter of 8 mm; hence, an 8×12 mm coupler has been used to connect the motor and the screw.

### V. Example Method

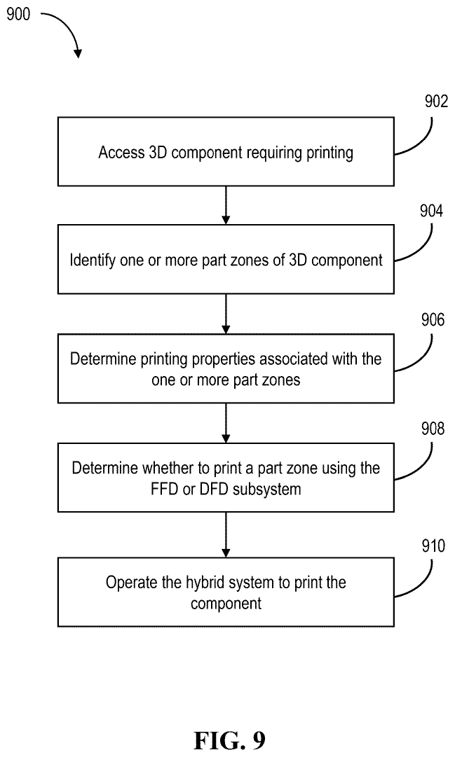

FIG. 9 shows an example method (900) for operating the hybrid system. In some examples, method (900) is executed by the processor of the system controller (402). In other examples, method (900) is executed by the controller processor, in combination with other processors (e.g., a processor of an external computing device).

As shown, at (902), a 3D component requiring printing is accessed (e.g., accessing the 3D component file). At (904), the 3D component file is parsed to identify one or more part zones. For example, this can include segmenting the 3D component into layers, and identifying each layer as a different part zone. In other cases, multiple layers can be associated with a single part zone.

At (906), the system determines various printing properties associated with each part zone. For example, this can involve determining if a part zone requires higher printed layer resolution (e.g., based on the part's mechanical quality requirements). In other cases, a part zone can require faster production rate.

In some cases, the part zones, and corresponding printing properties, are pre-defined in the 3D component file, e.g., by a user.

At (908), the system determines whether to print a given part zone using the FFD or DFD subsystems (102), (104). For example, the FFD subsystem (102) may be better suited for printing part zones requiring higher printing layer resolution, while the DFD subsystem (104) may be better suited for printing part zones allowing or requiring faster printing speeds or production rates (e.g., owing to the designs of the DFD subsystem, as described above).

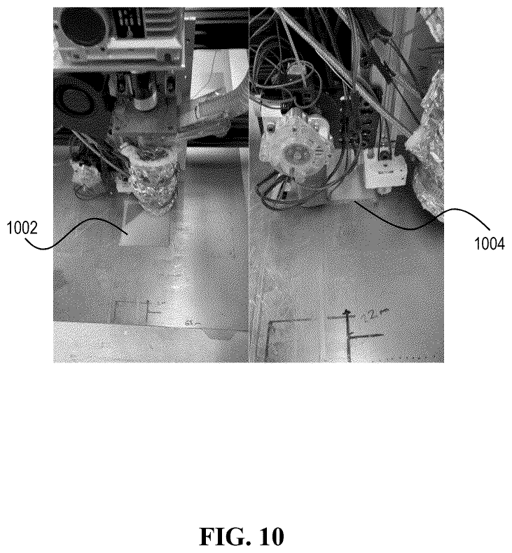

In some examples, part zones allowing or requiring faster printing speeds include bulk or volume internal part zones, or otherwise, large part zones required for mechanical supporting characteristics (e.g., bottom surface (1002) in FIG. 10). Accordingly, a DFD nozzle is used to quickly print these zones.

In other examples, FFD is used for higher printing resolution, e.g., part zones having higher aesthetic requirements. For example, printing the outer decorative surface (1004), in FIG. 10.

In at least one example, the printing properties of each part zone, is pre-defined during the design phase of the 3D component. For example, in the input file (e.g., CAD file), multi-material part zones can be input. Subsequently, in the simulation software for the 3D printing process, a multi-nozzle configuration is selected. A nozzle is then assigned for each part zone (e.g., FFD and DFD nozzle). For each nozzle type—various nozzle parameters can also be selected, e.g., a layer thickness, extrusion velocity and various other printing configurations.

At (910), the hybrid system is operated to print the components using the combination of the FFD and DFD subsystems (102), (104), e.g., as previously determined. For example, this can involve operating the motion assembly (204) (FIG. 3) to move the subsystems, and selectively operating each subsystem to print the associated part zones until the 3D component is fully printed (see e.g., FIG. 1).

### VI. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, user of the user device may download the application through an app store such as the Apple App Store™ or Google™ Play™.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A system for hybrid high-throughput additive deposition modelling, comprising:
(a) a fused filament deposition (FFD) subsystem;
(b) a direct fused deposition (DFD) subsystem;
(c) a motion assembly for moving the FFD and DFD subsystems along an X, Y and Z axes; and
(d) a controller configured to move both the FFD and the DFD subsystems in three dimensions, and control the deposition of plastic material by each of the FFD and DFD subsystems.

2. The system of claim 1 wherein the DFDM subsystem comprises a screw-extruder.

3. The system of claim 2, wherein the FFD subsystem comprises an extruder fan, cooling fan, heater, and temperature sensor, each operatively connected to the controller.

4. The system of claim 2 wherein the DFD subsystem comprises a nozzle, at least one heater, a temperature sensor, a cooling fan, and a stepper servo driver motor for rotating the screw-extruder, each operatively connected to the controller.

5. The system of claim 4 wherein the nozzle is sized to deliver a filament diameter size between about 1.75 mm to about 2.5 mm and/or a material flow rate of up to about 5 mm³/s.

6. The system of claim 1 wherein the system is configured to produce a part having at least one FFD zone and at least one DFD zone, and the controller is configured to control the FFD subsystem to deposit material in the at least one FFD zone and to control the DFD subsystem to deposit material in the at least one DFD zone.

7. A method of producing a part by additive deposition, wherein the part has at least one FFD zone and at least one DFD zone, the method comprising the step of operating a hybrid additive deposition system comprising an FFD subsystem and a DFD subsystem to deposit material in the at least one FFD zone using the FFD subsystem and in the at least one DFD zone using the DFD subsystem.

8. The method of claim 7 wherein either or both the FFD subsystem and the DFD subsystem are fed with recycled plastic material.

9. The method of claim 7 wherein material is deposited in the at least one DFD zone with a filament diameter size between about 1.75 mm to about 2.5 mm and/or a material flow rate of up to about 5 mm³/s.
